(19) United States
(12) Patent Application Publication
(10) Pub. No.: US 2015/0059416 A1
(43) Pub. Date: Mar. 5, 2015

(54) Systems and Methods for Detecting an Imbalanced Load in a Washing Machine Appliance Having a Balancing Apparatus

(71) Applicant: General Electric Company, Schenectady, NY (US)

(72) Inventors: Christopher Nils Naber, Louisville, KY (US); Richard Dean Suel, II, Louisville, KY (US)

(73) Assignee: General Electric Company, Schenectady, NY (US)

(21) Appl. No.: 14/012,025

(22) Filed: Aug. 28, 2013

(51) Int. Cl. D06F 37/20; D06F 33/02; G01M 1/16; D06F 37/22

(52) U.S. Cl. CPC D06F 37/203; D06F 37/225; D06F 33/02; G01M 1/16; D06F 2202/065; D06F 2202/10; D06F 2204/065; D06F 2222/00
USPC 68/140; 73/66

(57) ABSTRACT

An exemplary washing machine appliance includes a cabinet, a tub positioned within the cabinet, a drum rotatably mounted within the tub, a balancing apparatus configured to offset an imbalance created by articles in the drum, and a motor in mechanical communication with the drum. The motor is configured for selectively rotating the drum within the tub. The washing machine appliance includes a controller configured to perform operations. The operations include receiving a signal indicative of a speed of the motor. The operations include determining a deviation of the speed of the motor from a target motor speed and comparing the deviation to one or more threshold values. The operations include determining whether to perform a rebalancing process or a spin out process based on the comparison of the deviation to the one or more threshold values.

### FIELD OF THE INVENTION

The present disclosure relates generally to washing machine appliances. In particular, the present disclosure relates to systems and methods for detecting an imbalanced load in a washing machine appliance having a balancing apparatus.

### BACKGROUND OF THE INVENTION

Washing machine appliances generally include a tub with a drum rotatably mounted therein. The drum defines a wash chamber for receiving articles for washing. During operation of washing machine appliances, wash fluid is directed into the tub and onto articles within the wash chamber of the drum. The motor can rotate the drum at various speeds to agitate articles within the wash chamber in wash fluid, to wring wash fluid from articles within the wash chamber, etc.

In particular, after the articles of clothing have been washed, the washing machine can drain the wash fluid and then spin the drum at a high speed in order to relieve the articles of clothing of remaining moisture and fluid. This process is generally known as a spin cycle or a spin out process.

In certain circumstances, prior to a spin cycle, the load in the washing machine can become imbalanced. In particular, the articles of clothing can become disproportionately distributed to a single location and form an out of balance mass. For example, the articles of clothing can adhere together at a single location.

Such out of balance mass can cause a number of problems if it remains uncorrected and present during the spin cycle. In particular, the imbalanced mass can alter the center of mass for the drum and load as a whole so that the center of mass is no longer aligned with a shaft center of the washing machine. Rotating the drum at high speeds in such condition can cause undesirable vibration, noise, or other damage to system components, including damage caused by the drum becoming so far misaligned that is strikes the washing machine tub.

One known solution to an out of balance mass is the inclusion of a balancing apparatus within the washing machine. In general, a balancing apparatus can include a balancing material, such as a fluid or balance balls, that is allowed to freely rotate and move about the axis of rotation of the drum or motor. The balancing apparatus attempts to naturally counter the imbalance caused by the out of balance mass. However, a balancing apparatus is still insufficient to resolve the problems caused by a major imbalance or out of balance mass.

Therefore, systems and methods for detecting an imbalanced load in a washing machine appliance having a balancing apparatus are desired. In particular, knowledge of the presence of an imbalance can help determine whether a rebalancing process should be performed prior to a spin out process.

### BRIEF DESCRIPTION OF THE INVENTION

Additional aspects and advantages of the invention will be set forth in part in the following description, or may be apparent from the description, or may be learned through practice of the invention.

One aspect of the present disclosure is directed to a washing machine appliance. The washing machine appliance includes a cabinet, a tub positioned within the cabinet, and a drum rotatably mounted within the tub. The drum defines a wash chamber for receipt of articles for washing. The washing machine appliance includes a balancing apparatus configured to offset an imbalance created by the articles in the drum. The washing machine appliance includes a motor in mechanical communication with the drum. The motor is configured for selectively rotating the drum within the tub. The washing machine appliance includes a controller configured to perform operations. The operations include receiving a signal indicative of a speed of the motor. The operations include determining a deviation of the speed of the motor from a target motor speed and comparing the deviation to one or more threshold values. The operations include determining whether to perform a rebalancing process or a spin out process based on the comparison of the deviation to the one or more threshold values.

Another aspect of the present disclosure is directed to a method for detecting an imbalance of a load in a basket of a washing machine. The washing machine includes a motor configured to rotate the basket. The washing machine includes a balancing apparatus configured to counteract the imbalance of the load. The method includes operating the motor to rotate the basket and determining one or more characteristics of a deviation of a speed of the motor from a target motor speed. The method includes determining a total size of the load. The method includes detecting the imbalance of the load based on the one or more characteristics of the deviation and the total size of the load.

Another aspect of the present disclosure is directed to a method for determining whether to rebalance or spin out a load in a washing machine. The load includes an out of balance mass. The washing machine includes a motor and one or more balancing rings. The method includes operating the motor such that the one or more balancing rings and the out of balance mass come in and out of phase with each other. The method includes monitoring one or more characteristics of a deviation signal over a sampling period. The deviation signal describes an absolute difference between a speed of the motor and a motor set speed. The method includes obtaining one or more threshold values based on a total mass of the load. The method includes determining whether to rebalance or spin out the load based on a comparison of the one or more characteristics to the one or more threshold values.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a front, elevation view of a washing machine appliance according to an exemplary embodiment of the present disclosure;

FIG. 2 depicts a side, section view of the exemplary washing machine appliance of FIG. 1;

FIGS. 3A and 3B depict a method for operating a washing machine appliance according to an exemplary embodiment of the present disclosure;

FIG. 4 depicts a diagram of a washing machine appliance according to an exemplary embodiment of the present disclosure;

FIG. 5 depicts a graphical diagram of a motor speed signal over time according to an exemplary embodiment of the present disclosure;

FIG. 6 depicts a graphical diagram of speed deviation versus out of balance mass according to an exemplary embodiment of the present disclosure; and

FIG. 7 depicts a graphical diagram of threshold values versus total load mass according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

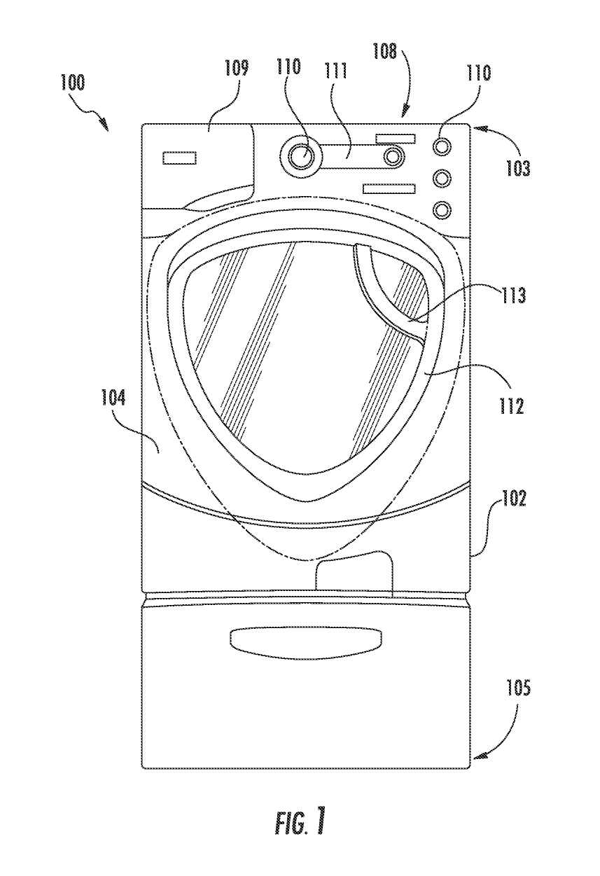

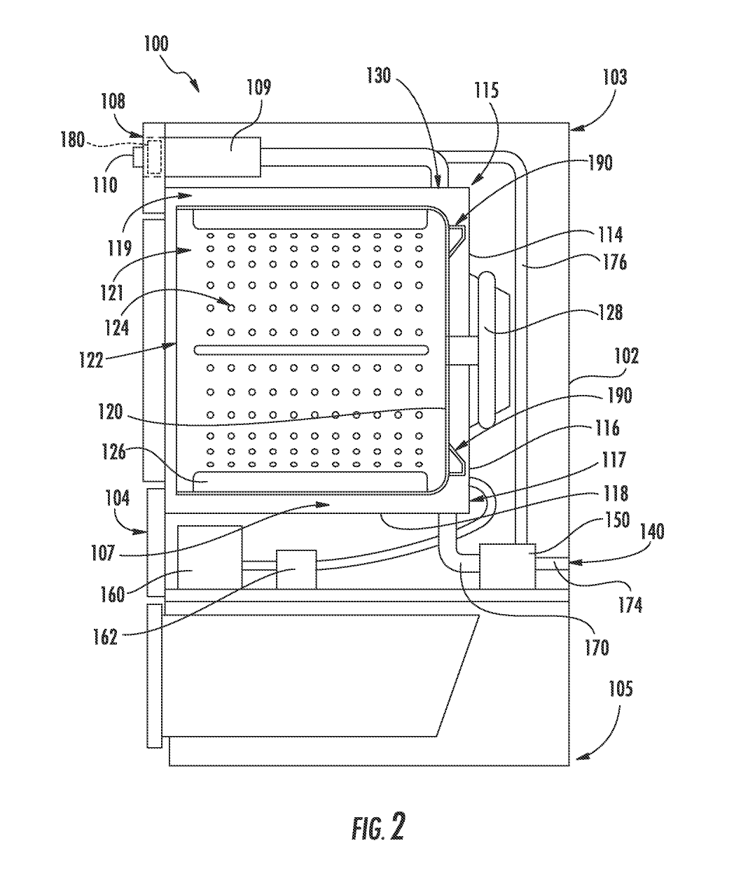

FIG. 1 provides a front, elevation view of an exemplary horizontal axis washing machine appliance 100. FIG. 2 provides a side, section view of washing machine appliance 100. As may be seen in FIG. 1, washing machine appliance 100 includes a cabinet 102 that extends between a top portion 103 and a bottom portion 105, e.g., along a vertical direction. Cabinet 102 also includes a front panel 104. A door 112 is mounted to front panel 104 and is rotatable about a hinge (not shown) between an open position facilitating access to a wash drum or basket 120 (FIG. 2) located within cabinet 102, and a closed position (shown in FIG. 1) hindering access to basket 120. A user may pull on a handle 113 in order to adjust door 112 between the open position and the closed position.

A control panel 108 including a plurality of input selectors 110 is coupled to front panel 104. Control panel 108 and input selectors 110 collectively form a user interface input for operator selection of machine cycles and features. For example, in one embodiment, a display 111 indicates selected features, a countdown timer, and/or other items of interest to machine users.

Referring now to FIG. 2, a tub 114 defines a wash compartment 119 configured for receipt of a washing fluid. Thus, tub 114 is configured for containing washing fluid, e.g., during operation of washing machine appliance 100. Washing fluid disposed within tub 114 may include at least one of water, fabric softener, bleach, and detergent. Tub 114 includes a back wall 116 and a sidewall 118 and also extends between a top 115 and a bottom 117, e.g., along the vertical direction.

Basket 120 is rotatably mounted within tub 114 in a spaced apart relationship from tub sidewall 118 and the tub back wall 116. Basket 120 defines a wash chamber 121 and an opening 122. Opening 122 of basket 120 permits access to wash chamber 121 of basket 120, e.g., in order to load articles into basket 120 and remove articles from basket 120. Basket 120 also defines a plurality of perforations 124 to facilitate fluid communication between an interior of basket 120 and tub 114. A sump 107 is defined by tub 114 and is configured for receipt of washing fluid during operation of appliance 100. For example, during operation of appliance 100, washing fluid may be urged by gravity from basket 120 to sump 107 through plurality of perforations 124.

A spout 130 is configured for directing a flow of fluid into tub 114. Spout 130 may be in fluid communication with a water supply (not shown) in order to direct fluid (e.g., clean water) into tub 114. A pump assembly 150 (shown schematically in FIG. 2) is located beneath tub 114 for draining tub 114 of fluid. Pump assembly 150 is in fluid communication with sump 107 of tub 114 via a conduit 170. Thus, conduit 170 directs fluid from tub 114 to pump assembly 150. Pump assembly 150 is also in fluid communication with a drain 140 via piping 174. Pump assembly 150 can urge fluid disposed in sump 107 to drain 140 during operation of appliance 100 in order to remove fluid from tub 114. Fluid received by drain 140 from pump assembly 150 is directed out of appliance 100, e.g., to a sewer or septic system.

In addition, pump assembly 150 is configured for recirculating washing fluid within tub 114. Thus, pump assembly 150 is configured for urging fluid from sump 107, e.g., to spout 130. For example, pump assembly 150 may urge washing fluid in sump 107 to spout 130 via hose 176 during operation of appliance 100 in order to assist in cleaning articles disposed in basket 120. It should be understood that conduit 170, piping 174, and hose 176 may be constructed of any suitable mechanism for directing fluid, e.g., a pipe, duct, conduit, hose, or tube, and are not limited to any particular type of mechanism.

A motor 128 is in mechanical communication with basket 120 in order to selectively rotate basket 120, e.g., during an agitation or a rinse cycle of washing machine appliance 100 as described below. Ribs 126 extend from basket 120 into wash compartment 119. Ribs 126 assist agitation of articles disposed within wash compartment 119 during operation of washing machine appliance 100. For example, ribs 126 may lift articles disposed in basket 120 during rotation of basket 120.

A drawer 109 is slidably mounted within front panel 104. Drawer 109 receives a fluid additive (e.g., detergent, fabric softener, bleach, or any other suitable liquid) and directs the fluid additive to wash compartment 119 during operation of washing machine appliance 100. Additionally, a reservoir 160 is disposed within cabinet 102. Reservoir 160 is also configured for receipt of fluid additive for use during operation of washing machine appliance 100 (shown in FIG. 1). Reservoir 160 is sized such that a volume of fluid additive sufficient for a plurality or multitude of wash cycles of washing machine appliance 100 may fill reservoir 160. Thus, for example, a user can fill reservoir 160 with fluid additive and operate washing machine appliance 100 for a plurality of wash cycles without refilling reservoir 160 with fluid additive. A reservoir pump 162 is configured for selective delivery of the fluid additive from reservoir 160 to tub 114.

Also shown in FIG. 2 is a balancing apparatus 190. For example, balancing apparatus 190 can include a balancing ring. The balancing ring can have an annular cavity in which a balancing material is free to rotate and move about. For example, the balancing material can be a fluid such as water or can be balancing balls. The balancing ring can include one or more interior baffles.

Although a single balancing ring or apparatus 190 is shown in FIG. 2, any number of such rings or apparatuses can be included in washing machine appliance 100 and can be placed according to any known or desirable configuration. For example, two balancing rings can be respectively placed at the front and back of basket 120.

Operation of washing machine appliance 100 is controlled by a processing device or controller 180 that is operatively coupled to control panel 108 for user manipulation to select washing machine cycles and features. In response to user manipulation of control panel 108, controller 180 operates the various components of washing machine appliance 100 to execute selected machine cycles and features.

Controller 180 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 180 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 58 and other components of washing machine appliance 50 may be in communication with controller 180 via one or more signal lines or shared communication busses.

Controller 180 is in operative communication with motor 128. Thus, controller 180 can selectively activate and operate motor 128, e.g., depending upon a wash cycle selected by a user of washing machine appliance 100. Controller 180 is also configured for monitoring a power delivered to motor 128. As will be understood by those skilled in the art, power delivered to motor 128 can be measured or determined by controller 180 utilizing various methods. As an example, controller 180 or motor 128 may include a power measurement circuit. In alternative exemplary embodiments, controller 180 may monitor the power delivered to motor 128 utilizing any other suitable mechanism or method.

Likewise, controller 180 or other processing components of washing machine appliance 100 can determine a current speed of motor 128 according to any known techniques. For example, a speed signal describing the current speed of the motor can be created and provided to controller 180 according to back electromotive force techniques or based on the output of one or more sensors or other components.

In an illustrative example of operation of washing machine appliance 100, laundry items are loaded into basket 120, and washing operation is initiated through operator manipulation of input selectors 110. Tub 114 is filled with water and detergent to form a wash fluid. One or more valves (not shown) can be actuated by controller 180 to provide for filling tub 114 to the appropriate level for the amount of articles being washed. Once tub 114 is properly filled with wash fluid, the contents of basket 120 are agitated with ribs 126 for cleansing of laundry items in basket 120.

After the agitation phase of the wash cycle is completed, tub 114 is drained. Laundry articles can then be rinsed by again adding wash fluid to tub 114, depending on the particulars of the cleaning cycle selected by a user, ribs 126 may again provide agitation within wash compartment 119. One or more spin cycles may also be used. In particular, a spin cycle may be applied after the wash cycle and/or after the rinse cycle in order to wring wash fluid from the articles being washed. During a spin cycle, basket 120 is rotated at relatively high speeds.

While described in the context of a specific embodiment of horizontal axis washing machine appliance 100, using the teachings disclosed herein it will be understood that horizontal axis washing machine appliance 100 is provided by way of example only. Other washing machine appliances having different configurations, different appearances, and/or different features may also be utilized with the present subject matter as well, e.g., vertical axis washing machine appliances.

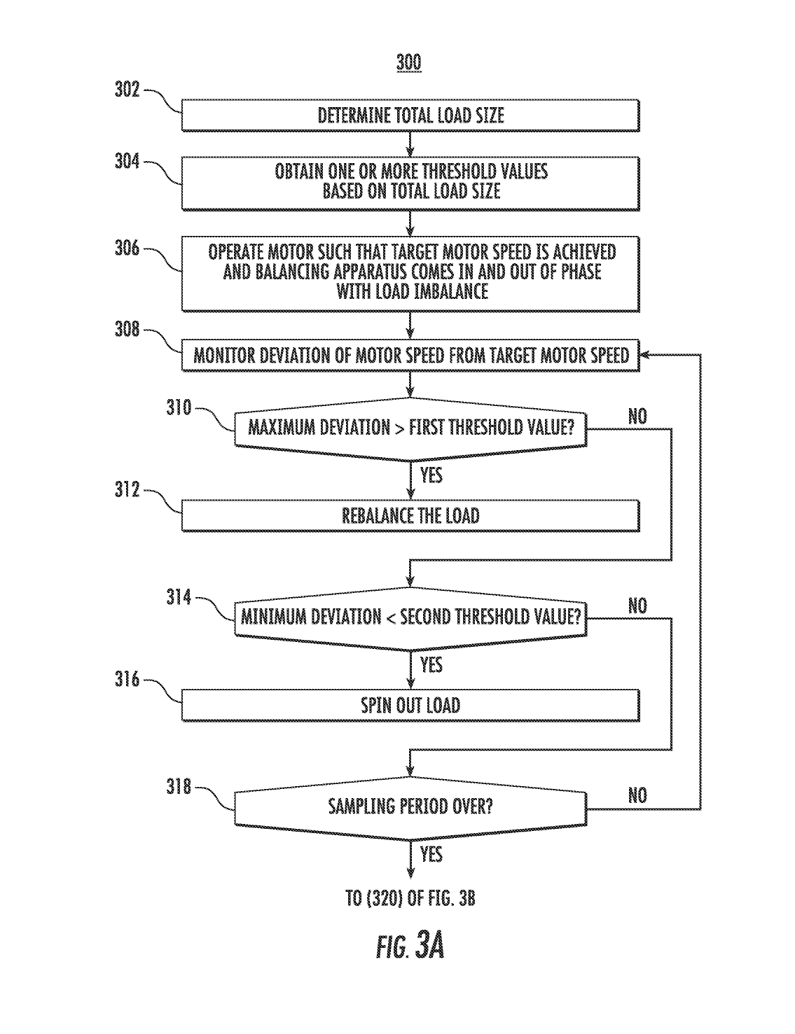

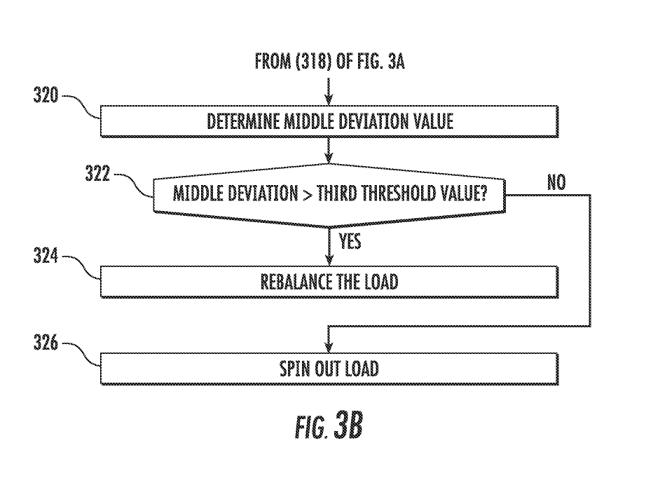

FIGS. 3A and 3B depict an exemplary method (300) for operating a washing machine appliance according to an exemplary embodiment of the present disclosure. Method (300) can be implemented using any suitable appliance or other device, including, for example, washing machine appliance 100 of FIG. 1.

In addition, FIGS. 3A and 3B depict steps performed in a particular order for purposes of illustration and discussion. Those of ordinary skill in the art, using the disclosures provided herein, will understand that the various steps method (300) can be omitted, adapted, and/or rearranged in various ways.

Referring now to FIG. 3A, at (302) a total load size can be determined. For example, one or more load size determination algorithms or processes can be performed by washing machine appliance 100 to determine a total size of the load in pounds or other units of mass. For example, the total load size can be determined based upon an amount of power, current, or other electrical characteristics required to operate the motor to bring the load to a particular rotational speed. As another example, one or more sensors can be used to determine the weight of the contents of the drum. As yet another example, user inputs can be analyzed or water displacement can be measured to assist in determining the total load size. Generally, any known technique can be performed at (302).

At (304) one or more threshold values can be obtained based on the total load size determined at (302). As an example, a first, second, and third threshold value can be obtained based on the total load size. The threshold value(s) can be obtained from a lookup table stored in system memory or can be obtained by entering the total load size into one or more transfer functions.

At (306) the motor can be operated such that a target motor speed is achieved and a balancing apparatus is allowed to come in and out of phase with an out of balance mass or other existing load imbalance. As an example, a controller can operate the motor such that it spins at 100 RPM. After achieving such speed, control of the motor can be switched from a constant speed control to a constant power or constant torque control. When in constant power mode, the basket speed can fluctuate and the balancing apparatus can come in and out of phases with the out of balance mass.

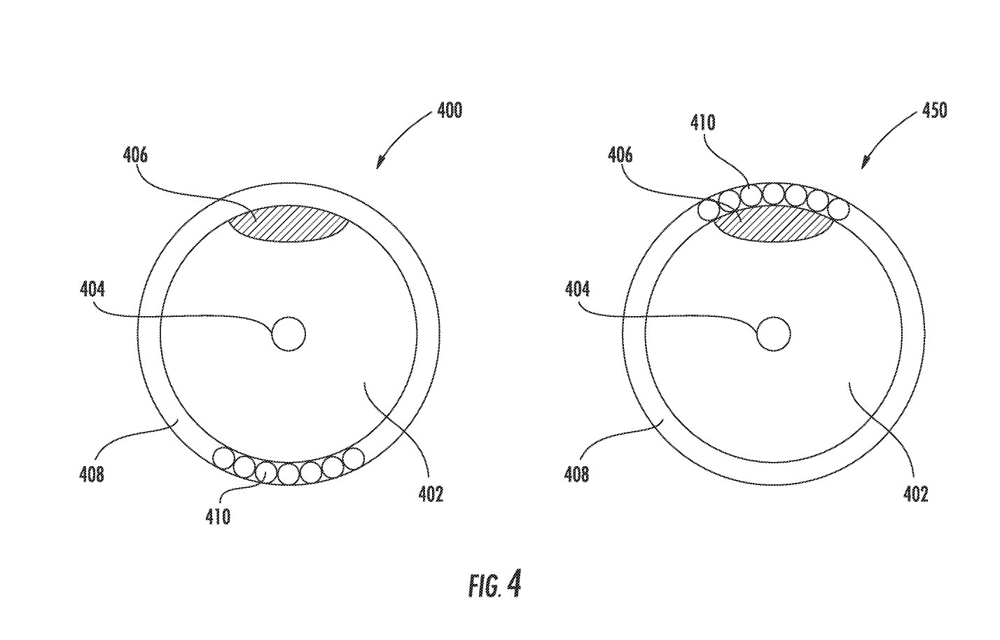

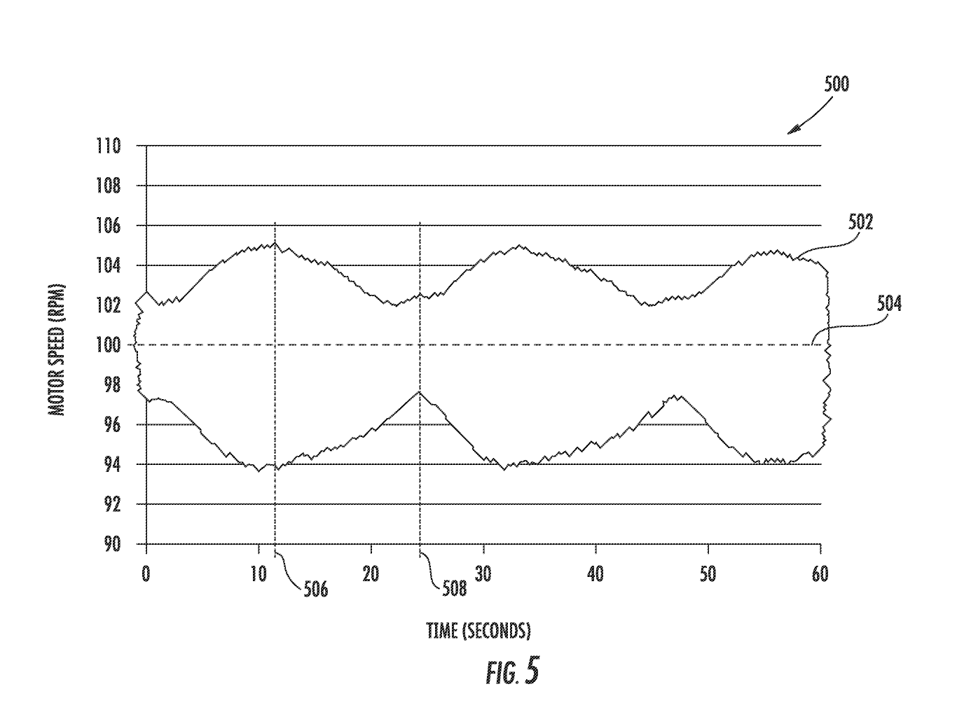

To illustrate these principles reference will now be made to FIGS. 4 and 5. FIG. 4 depicts a diagram of a washing machine appliance according to an exemplary embodiment of the present disclosure. In particular, diagrams 400 and 450 depict a drum 402 rotatably mounted about a shaft 404. In the wash chamber of drum 402 is an out of balance mass 406. Surrounding drum 402 is a balancing ring 408. A balancing material, such as balance balls 410 rotate about shaft 404 through an interior cavity of balancing ring 408.

In diagram 400, the balancing ring 408 is completely out of phase with the out of balance mass 406 (i.e. 180 degrees out of phase). In particular, the center of mass of balance balls 410 is on the rotationally opposite side of shaft 404 from the out of balance mass 406.

To the contrary, in diagram 450, the balancing ring 408 is in phase with the out of balance mass 406. In particular, the center of mass of balance balls 410 is aligned with out of balance mass 406 with respect to shaft 404.

FIG. 5 depicts a graphical diagram 500 of a motor speed signal 502 over time according to an exemplary embodiment of the present disclosure. In particular, graphical diagram 500 shows a deviation of motor speed signal 502 from a target speed or set speed 504 over time while a balancing apparatus comes in and out of phase with an out of balance mass. For example, the deviation of motor speed signal 502 from set speed 504 at any given time can equal an absolute value of the difference between motor speed signal 502 and set speed 504 at such time.

According to an aspect of the present disclosure, when the balancing apparatus is directly in phase with the out of balance mass, the deviation of motor speed signal 502 from the set speed 504 will be at its greatest, as the balancing apparatus contributes to the imbalance caused by the out of balance mass. To the contrary, when the balancing apparatus is 180 degrees out of phase with the out of balance mass, the deviation of motor speed signal 502 from set speed 504 will be at its smallest, as the balancing apparatus successfully offsets the out of balance mass.

As can generally be seen from graphical depiction 500, the deviation of motor speed signal 502 from set speed 504 exhibits a local maximum at time 506. Therefore, as discussed above, time 506 can correspond to an instance in which the balancing apparatus is in phase with the out of balance mass, such as, for example, depicted in diagram 450.

To the contrary, as can generally be seen from graphical depiction 500, the deviation of motor speed signal 502 from set speed 504 exhibits a local minimum at time 508. Therefore, time 508 can correspond to an instance in which the balancing apparatus is 180 degrees out of phase with the out of balance mass, such as, for example, depicted in diagram 400.

Thus, one of skill in the art will appreciate, in light of the disclosures contained herein, that operating the motor such that the balancing apparatus comes in and out of phase with the out of balance mass can result in a motor speed signal that exhibits a periodic increase and decrease in deviation from a target speed, as generally shown in FIG. 5.

Returning again to FIG. 3A, once the balancing apparatus begins to come in and out of phase with the load imbalance at (306), a deviation of the motor speed from a target motor speed can be monitored at (308). As an example, the deviation of the motor speed from the target speed can equal an absolute value of the difference between the motor speed and the target speed. In some embodiments, monitoring the deviation of the motor speed from the target speed at (306) can include determining a maximum deviation and a minimum deviation exhibited over a sampling period. The sampling period can be any suitable length, such as, for example, 60 or 75 seconds.

In further embodiments of the present disclosure, monitoring the deviation of the motor speed from the target speed at (306) can include continuously calculating a moving average of the deviation. As an example, a rolling window of 3 seconds can be used to calculate a plurality of moving average values over the sampling period. The maximum deviation can be the maximum moving average value calculated during the sampling period and the minimum deviation can be the minimum moving average value calculated during the sampling period.

As yet another example, monitoring the deviation of the motor speed from the target speed at (306) can include calculating a deviation score based on the deviation of the motor speed from the target speed and other parameters. The maximum deviation can be the maximum deviation score and the minimum deviation can be the minimum deviation score. Other characteristics of the motor speed signal can be analyzed as well, including, for example, a median deviation, a mean deviation, a median moving average deviation, a mean moving average deviation, frequency, or any other suitable motor speed signal or deviation signal characteristics.

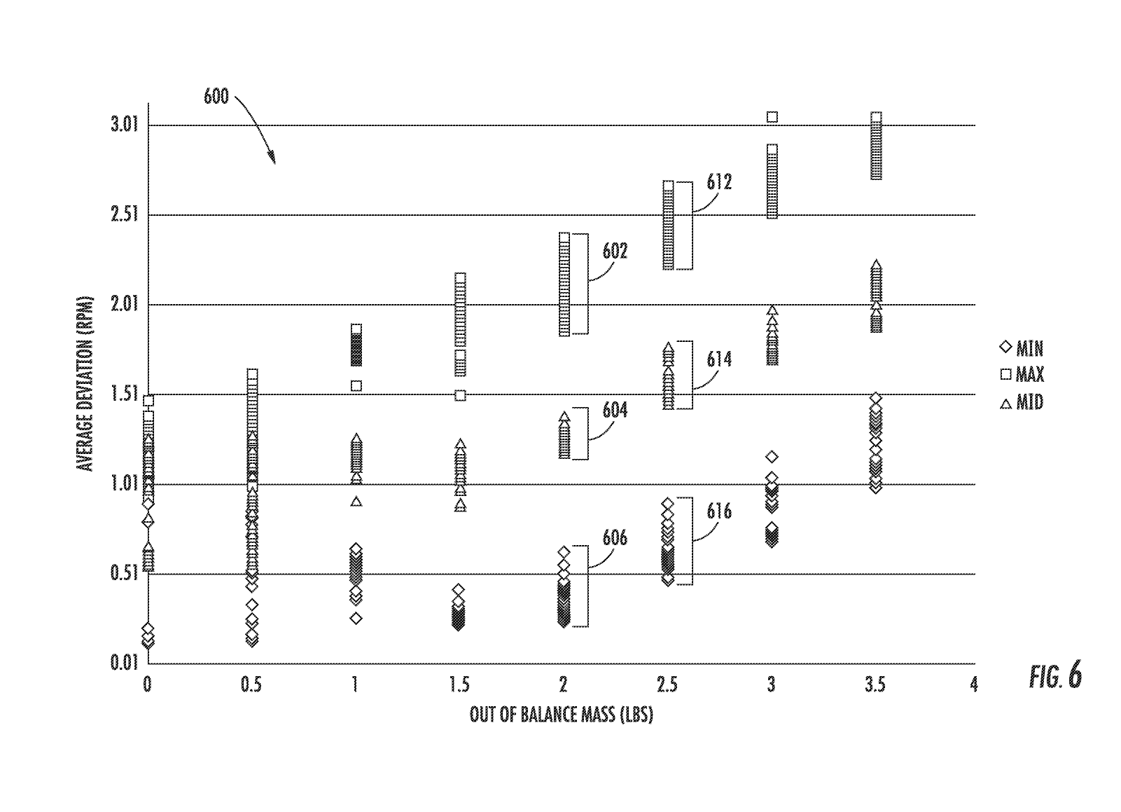

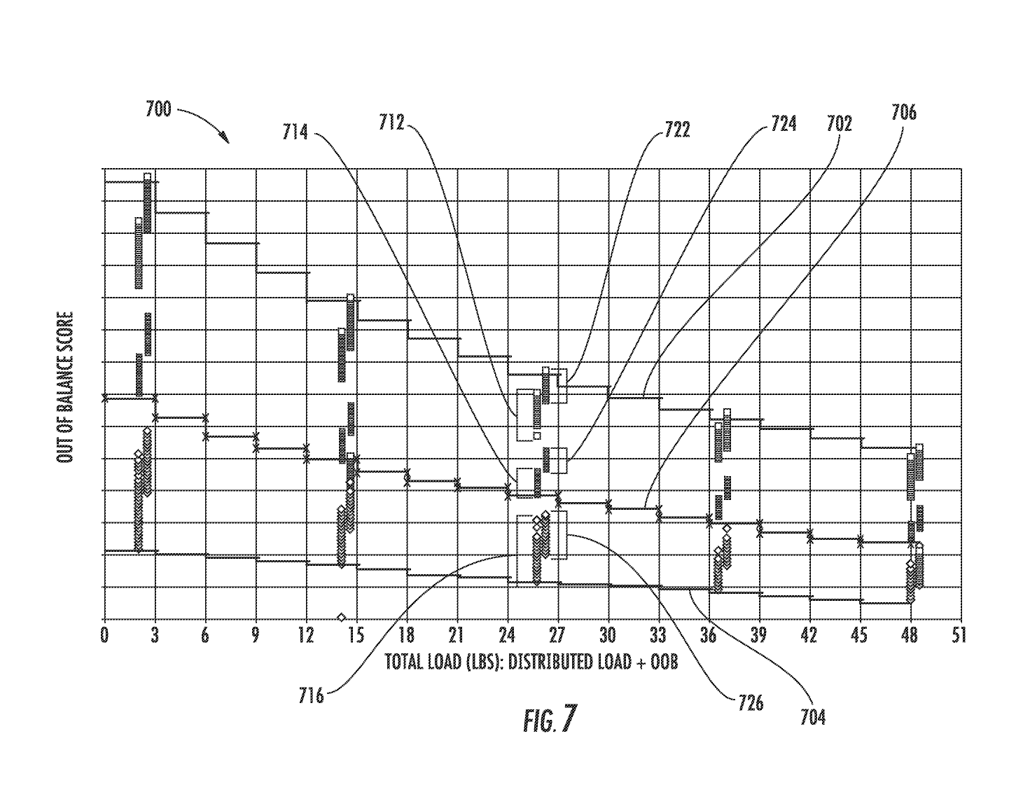

According to another aspect of the present disclosure, the deviation of the motor speed signal from the target speed can be generally proportional to a ratio of the out of balance mass to the total load size. Thus, as the degree of imbalance of the load in the wash chamber increases, the deviation of the motor speed signal from the target speed signal will also increase. To illustrate such principle, reference will now be made to FIGS. 6 and 7.

FIG. 6 depicts a graphical diagram 600 of speed deviation versus out of balance mass according to an exemplary embodiment of the present disclosure. In particular, graphical diagram 600 shows eight sets of data corresponding to eight different mass values for an out of balance mass.

Each set of data includes three data groupings respectively corresponding to maximum observed deviations, middle deviations, and minimum observed deviations for a plurality of measurement cycles. In particular, the washing machine can have been operated according to aspects of method (300) for each of such plurality of measurement cycles. In some implementations, including the exemplary data shown in FIG. 6, the middle deviation for each measurement cycle can equal an average of the maximum deviation and the minimum deviation for such measurement cycle.

As an example, data grouping 602 shows a first plurality of maximum deviations respectively associated with a first plurality of measurement cycles conducted with an out of balance mass of 2 pounds present in the wash basket; data grouping 604 shows a first plurality of middle deviations respectively associated with such first plurality of measurement cycles; and data grouping 606 shows a first plurality of minimum deviations respectively associated with the first plurality of measurement cycles.

Likewise, data grouping 612 shows a second plurality of maximum deviations respectively associated with a second plurality of measurement cycles conducted with an out of balance mass of 2.5 pounds present in the wash basket; data grouping 614 shows a second plurality of middle deviations respectively associated with such second plurality of measurement cycles; and data grouping 616 shows a second plurality of minimum deviations respectively associated with the second plurality of measurement cycles.

Thus, it can be seen from graphical depiction 600 that the deviation values generally increase as the out of balance mass increases. In particular, beginning at about 1.5 or 2 pounds of out of balance mass and upwards, it can be seen that there is generally a linear relationship between an increase in out of balance mass and each of the three data groupings of deviation values for each data set.

It should be appreciated, however, that the data provided in FIGS. 6 and 7 are representative of an exemplary embodiment of a washing machine. The present disclosure is in no way limited to the particular values or relationships shown by such data. As different washing machine appliances have varying components, designs, attributes, operational parameters, or other design variables or objectives, application of the teachings and disclosures of the present disclosure to different washing appliances can result in varying operational data.

FIG. 7 depicts a graphical diagram 700 of threshold values versus total load mass according to an exemplary embodiment of the present disclosure. In particular, plots 702, 704, and 706 respectively graph a first threshold value, a second threshold value, and a third threshold value versus total load mass. More particularly, plot 702 graphs a first threshold value that can be compared to a maximum deviation, plot 704 graphs a second threshold value that can be compared to a minimum deviation, and plot 706 graphs a third threshold value that can be compared to a middle deviation, according to aspects of the present disclosure.

Also shown on graphical diagram 700 is ten sets of data forming five associated pairs. As an example, a first data set can include data groupings 712, 714, and 716, while a second data set can include data groupings 722, 724, and 726. The first data set and the second data set are an associated pair.

Each pair of data sets shown in FIG. 7 represents maximum, middle, and minimum deviations for a plurality of measurement cycles conducted with a 2 pound out of balance mass and a plurality of measurement cycles conducted with a 2.5 pound out of balance mass.

As an example, the first data set that includes data groupings 712, 714, and 716 represents a plurality of measurement cycles conducted with a distributed load size of about 24 pounds and an out of balance mass of about 2 pounds. Thus, the first data set represents measurement cycles conducted with a total load size of about 26 pounds. Data groupings 712, 714, and 716 respectively represent maximum, middle, and minimum deviations associated with such plurality of measurement cycles.

Likewise, the second data set that includes data groupings 722, 724, and 726 represents a plurality of measurement cycles conducted with a distributed load size of about 24 pounds and an out of balance mass of about 2.5 pounds. Thus, the second data set represents measurement cycles conducted with a total load size of about 26.5 pounds. Data groupings 722, 724, and 726 respectively represent maximum, middle, and minimum deviations associated with such plurality of measurement cycles.

Thus, the five associated pairs of data sets depicted in FIG. 7 provide an indication of expected deviations for an exemplary washing machine having a 2 or 2.5 pounds out of balance mass across a variety of total load sizes.

One of skill in the art, in light of the disclosures provided herein, will appreciate that the data provided by such associated pairs of data sets has been used to design, select, or otherwise obtain the plots 702, 704, and 706 for the threshold values. In particular, such threshold values have been designed so as to assist in classifying later observed deviation data as generally indicative of an imbalanced load as either greater than or less than 2.5 or 2 pounds.

It will be appreciated, however, that the selection of threshold values based on deviation data representing 2 pounds and 2.5 pounds out of balance mass is exemplary in nature and driven by the particular design goals and constraints of a particular exemplary washing machine appliance.

Instead, according to aspects of the present disclosure, threshold values can be designed, selected, or obtained to assist in classifying later observed deviation data as indicative of an imbalanced load either greater or less than any acceptable limit of out of balance mass. Such acceptable limit can be generally based on machine capabilities, design choices with respect to noise, vibration, tub strike avoidance, or any other attributes, operational parameters, or other design variables or objectives. The selection of threshold values can also take into account spin cycle speed, spin cycle duration, balancing apparatus capabilities, component reliabilities, wet load dynamics, total load size measurement accuracy or expected error, out of balance mass measurement accuracy (e.g. standard deviation), or system component variation.

Thus, the first, second, and third threshold values respectively represented by plots 702, 704, and 706 can be derived from data observed during measurement cycles. In particular, the first, second, and third threshold values can be stored in memory as a lookup table or can otherwise be described by one or more transfer functions that provide an approximation of plots 702, 704, and 706. Such threshold values can be the values obtained at (304) of FIG. 3A.

Returning now to FIG. 3A, once monitoring of the deviation of the motor speed from the target motor speed has begun at (308), then at (310) it can be determined whether a maximum deviation is greater than a first threshold value. For example, the maximum deviation presently observed during the sampling period can be compared to a first threshold value that was obtained at (304).

If it is determined at (310) that the maximum deviation is greater than the first threshold value, then method (300) can proceed to (312) and rebalance the load. In particular, if the maximum deviation is greater than the first threshold value, then it can be assumed that the load contains an unacceptably large imbalance such the rebalancing should be performed prior to any spin cycle so as to prevent unacceptable noise, vibration, or damage. Rebalancing the load at (312) can include any operational process or technique that provides for a rebalancing of the load. For example, the basket can rotate slowly to allow the out of balance mass to tumble down and be disrupted by the center shaft. Generally, any known technique to rebalance the load can be performed at (312).

However, if it is determined at (310) that the maximum deviation is less than or equal to the first threshold value, then method (300) can proceed to (314). At (314) it can be determined whether a minimum deviation is less than a second threshold value. For example, the minimum deviation presently observed during the sampling period can be compared to a second threshold value that was obtained at (304).

If it is determined at (314) that the minimum deviation is less than the second threshold value, then method (300) can proceed to (316) and spin out the load. In particular, if the minimum deviation is less than the second threshold value, then it can be assumed that the load does not contain an unacceptably large imbalance and, therefore, the spin cycle can be performed without unacceptable noise, vibration, or damage. Spinning out the load at (316) can include any known process or technique for reducing the fluid content of the articles of clothing in the basket, including spinning the basket at a high speed.

However, if it is determined at (314) that the minimum deviation is greater than or equal to the second threshold value, then method (300) can proceed to (318). At (318) it is determined whether the sampling period is over. For example, a timer can count down or up to a predetermined sampling period value.

If it is determined at (318) that the sampling period is not completed, then method (300) can return to (308) and continue monitoring the deviation of the motor speed from the target motor speed. In such fashion, if the maximum deviation is greater than the first threshold value or the minimum deviation is less than the second threshold value at any point during the sampling period, then the appropriate actions can be taken. However, if neither of such conditions are met, method (300) will continue monitoring for the remainder of the sampling period.

However, if it is determined at (318) that the sampling period has been completed, then method (300) can proceed to (320) of FIG. 3B.

Referring now to FIG. 3B, at (320) a middle deviation value can be determined. In some implementations, the middle deviation value can be an average of the maximum deviation and the minimum deviation value observed during the sampling period. However, other techniques can be used to obtain the middle deviation value at (320), including identifying a median value for all observed deviation values, a mean value for all observed deviation values, or any other suitable technique, including weighted averages or transfer functions.

At (322) it can be determined whether the middle deviation value is greater than a third threshold value. For example, the middle deviation value determined at (320) can be compared to a third threshold value that was obtained at (304) of FIG. 3A.

If it is determined at (322) that the middle deviation value is greater than the third threshold value, then method (300) can proceed to (324) and rebalance the load. However, if it is determined at (322) that the middle deviation value is less than or equal to the third threshold value, then method (300) can proceed to (326) and spin out the load.

In such fashion, a washing machine appliance implementing method (300) can analyze a deviation of a motor speed from a target speed while a balancing apparatus comes in and out of phase with an out of balance load to detect and resolve an unacceptably large load imbalance prior to performing a high speed spin out cycle.

Furthermore, while method (300) includes determining the total load size at (302) prior to monitoring deviation for a sampling period at (308), it will be appreciated that, in alternative implementations, the total load size could be determined subsequent to monitoring of the deviation such that the results of monitoring can then be interpreted.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A washing machine appliance, comprising:
a cabinet;
a tub positioned within the cabinet;
a drum rotatably mounted within the tub, the drum defining a wash chamber for receipt of articles for washing;
a balancing apparatus configured to offset an imbalance created by the articles in the drum;
a motor in mechanical communication with the drum, the motor configured for selectively rotating the drum within the tub; and
a controller configured to perform operations, the operations comprising:
receiving a signal indicative of a speed of the motor;
determining a deviation of the speed of the motor from a target motor speed;
comparing the deviation to one or more threshold values; and
determining whether to perform a rebalancing process or a spin out process based on the comparison of the deviation to the one or more threshold values.

2. The washing machine appliance of claim 1, wherein the controller is configured to perform further operations comprising:
operating the motor to reach the target motor speed; and
after the target motor speed is reached, controlling the motor to operating at a constant power;
wherein the step of determining the deviation is performed while the motor is controlled to operate at the constant power.

3. The washing machine appliance of claim 1, wherein a phase difference between the balancing apparatus and the imbalance fluctuates in value while the step of determining the deviation is performed.

4. The washing machine appliance of claim 1, wherein determining the deviation of the speed of the motor from the target motor speed comprises:
determining a maximum deviation;
determining a minimum deviation; and
determining a middle deviation, the middle deviation being the average of the maximum deviation and the minimum deviation.

5. The washing machine appliance of claim 4, wherein:
determining the deviation of the speed of the motor from the target motor speed comprises calculating a moving average of the speed of the motor over a sampling period;
the maximum deviation comprises a maximum value exhibited by the moving average over the sampling period; and
the minimum deviation comprises a minimum value exhibited by the moving average over the sampling period.

6. The washing machine appliance of claim 4, wherein comparing the deviation to one or more threshold values comprises:
comparing the maximum deviation to a first threshold value;
comparing the minimum deviation to a second threshold value; and
comparing the middle deviation to a third threshold value.

7. The washing machine appliance of claim 6, wherein determining whether to perform the rebalancing process or the spin out process comprises determining that the rebalancing process should be performed when the maximum deviation is greater than the first threshold value.

8. The washing machine appliance of claim 6, wherein determining whether to perform the rebalancing process or the spin out process comprises determining that the spin out process should be performed when the minimum deviation is less than the second threshold value.

9. The washing machine appliance of claim 1, wherein the controller is configured to perform further operations comprising, prior to comparing the deviation to the one or more threshold values:
determining a load size; and
determining the one or more threshold values based on the load size.

10. The washing machine appliance of claim 9, wherein determining the one or more threshold values based on load size comprises one of entering the load size into a transfer function or using the load size to obtain the one or more threshold values from a look-up table.

11. A method for detecting an imbalance of a load in a basket of a washing machine, the washing machine comprising a motor configured to rotate the basket and a balancing apparatus configured to counteract the imbalance of the load, the method comprising:
operating the motor to rotate the basket;
determining one or more characteristics of a deviation of a speed of the motor from a target motor speed;
determining a total size of the load; and
detecting the imbalance of the load based on the one or more characteristics of the deviation and the total size of the load.

12. The method of claim 11, wherein the motor is operated to rotate the basket in such fashion as to permit the balancing apparatus to come in and out of phase with the imbalance of the load.

13. The method of claim 11, wherein the one or more characteristics comprises a maximum deviation.

14. The method of claim 13, wherein detecting the imbalance of the load based on the one or more characteristics of the deviation and the total size of the load comprises:
obtaining a threshold value based on the total size of the load; and
detecting the imbalance of the load when the maximum deviation is greater than the threshold value.

15. The method of claim 14, wherein the maximum deviation comprises a maximum value exhibited by a moving average of the deviation over a sampling period.

16. The method of claim 11, wherein the one or more characteristics comprises a minimum deviation.

17. The method of claim 16, wherein detecting the imbalance of the load based on the one or more characteristics of the deviation and the total size of the load comprises:
obtaining a threshold value based on the total size of the load; and
detecting that the load is balanced when the minimum deviation is less than the threshold value.

18. The method of claim 17, wherein the minimum deviation comprises a minimum value exhibited by a moving average of the deviation over a sampling period.

19. A method for determining whether to rebalance or spin out a load in a washing machine, the load comprising an out of balance mass, the washing machine comprising a motor and one or more balancing rings, the method comprising:
operating the motor such that the one or more balancing rings and the out of balance mass come in and out of phase with each other;
monitoring one or more characteristics of a deviation signal over a sampling period, the deviation signal describing an absolute difference between a speed of the motor and a motor set speed;
obtaining one or more threshold values based on a total mass of the load; and
determining whether to rebalance or spin out the load based on a comparison of the one or more characteristics to the one or more threshold values.

20. The method of claim 19, wherein:
monitoring or more characteristics of the deviation signal comprises determining a maximum and a minimum of a moving average of the deviation signal;
obtaining the one or more threshold values based on the total mass comprises obtaining a first threshold value and a second threshold value based on the total mass; and
determining whether to rebalance or spin out the load based on the comparison comprises:
rebalancing the load when the maximum is greater than the first threshold value; and
performing a spin out of the load when the minimum is less than the second threshold value.
